(19) United States
(12) Patent Application Publication
(10) Pub. No.: US 2025/0139140 A1
(43) Pub. Date: May 1, 2025

(54) METHOD AND SYSTEM FOR CONTEXT-AWARE TELECOMMUNICATIONS, CELLULAR, AND RADIO BASED GENERATIVE PRE-TRAINED TRANSFORMER

(71) Applicant: Aira Technologies, Inc., Saratoga, CA (US)

(72) Inventors: Ravikiran Gopalan, Saratoga, CA (US); Yihan Jiang, Cupertino, CA (US); Jash Rathod, Saratoga, CA (US); Rahul Vippala, Saratoga, CA (US)

(21) Appl. No.: 18/931,972

(22) Filed: Oct. 30, 2024

Related U.S. Application Data
(60) Provisional application No. 63/546,708, filed on Oct. 31, 2023.

(51) Int. Cl. G06F 16/332; G06F 16/33

(52) U.S. Cl. CPC G06F 16/3329; G06F 16/3344

(57) ABSTRACT

This disclosure relates to methods, systems, and devices for AI/ML assisted management of a radio access network (RAN). In particular, an LLM is employed to generate answer to user queries, for example in the form of code that can be executed upon streaming data from the RAN, including performance management and control management databases. To provide prompts the LLM can understand, an LLM agent employs a knowledge base and experience base to transform the language of the queries from the highly technical telecommunications domain to a general domain. Frequently asked questions and their answers may be stored in the experience base and used instead of using the LLM.

### CROSS-REFERENCE TO RELATED APPLICATION

This application claims the benefit of and priority to U.S. Provisional Patent Application No. 63/546,708, entitled “METHOD AND SYSTEM FOR CONTEXT-AWARE TELECOMMUNICATIONS, CELLULAR, AND RADIO BASED GENERATIVE PRE-TRAINED TRANSFORMER (RANGPT)”, filed on Oct. 31, 2023, which is incorporated herein by reference in its entirety.

### TECHNICAL FIELD

The present invention relates generally to the field of telecommunications and radio access networks (RAN), and more particularly to systems and methods that leverage advanced machine learning models, such as generative pre-trained transformers, to enhance the performance and accuracy of natural language query processing in cellular and radio networks. Specifically, the invention involves a hybrid retrieval system that combines traditional vector-based search techniques with fine-tuned language models to support context-aware user queries related to network performance, management, and operations.

### BACKGROUND

Managing a complex system requires collection of vast amounts of data, analysis of the data, and controlling the system based on the analysis. One such complex system is the telecommunication Radio Access Network (RAN).

In a RAN, data collection includes continuous monitoring of the RAN for anomalous events. Successfully monitoring the network on various key performance indicators (KPI) is critical to inform the operator of current situations. Currently, monitoring the network is a manual process that includes (1) observing dashboards, which is flexible but tedious and error-prone, and (2) manually writing fixed listener codes to be triggered, which may increase reliability but may not be flexible or interactive, and requires extensive human knowledge of the RAN.

This data collection also includes querying the RAN for particular specified data. Currently, querying the RAN is a manual process that includes (1) observing vendor-defined dashboards, (2) observing configuration files, and (3) writing database queries. These manual approaches are not sufficient and tend to be limited and error-prone. In addition, querying a RAN typically requires technical expertise and the use of structured query languages or specialized tools. However, the rise of natural language processing (NLP) systems, particularly those leveraging machine learning models like Generative Pre-trained Transformers (GPTs), has enabled non-technical users to interact with network management systems through natural language queries.

Observing the vendor-defined dashboard is a stable and reliable process. However, this approach is restrictive because only predefined dashboards can be observed. And this approach is not flexible. For example, monitoring out-of-scope KPIs is impossible until the KPIs are requested and the vendor completes that implementation, a process that can take several months. Moreover, to avoid omitting information, dashboards are designed to be redundant, which may become overwhelming for inexperienced users.

Observing configuration files by experienced human operators is very flexible. For example, a human can discern when two tables with different names are of the same column using the human's domain knowledge. However, this manual process is prone to error. Moreover, the work requires extensive experience, and the essence of the work is repetitive and tedious.

Writing query code is efficient and flexible. The major disadvantage with this approach is the high requirements of users responsible for writing the code: they must possess domain knowledge of both radio access network operations and coding. For one time usage queries, this approach is generally not cost effective.

Analysis of radio access network issues is the most common operational task. The network analyst needs to understand the huge amount of logged data to identify a root cause that is supported by the existing knowledge base, which includes documents such as specifications and design documents. Currently the analysis is performed manually, and requires extensive human domain knowledge.

### SUMMARY

In accordance with one or more embodiments, various features and functionality are provided to enable AI assisted management of a radio access network (RAN). In particular, a large language model (LLM) is employed to generate answers to user queries. The answers may take the form of code that can be executed upon streaming data from the RAN, including performance management and control management databases. To provide prompts that the LLM can understand, an LLM agent employs a knowledge base and experience base to transform the language of the queries from the highly technical telecommunications domain to a general domain. Frequently asked questions and their answers may be stored in the experience base and the answers used without applying the questions in prompts to the LLM.

In general, one aspect disclosed features a method, comprising: receiving a query for information relating to a system, the query including language specific to a knowledge domain of the system; modifying the query according to a knowledge base, the knowledge base including correspondences between language specific to the knowledge domain of the system and language in a general knowledge domain; applying the modified query in a prompt to a large language model (LLM); receiving, from the LLM, an answer to the prompt; obtaining the information by applying the answer to a data set that describes the system; and transmitting the obtained information relating to the system.

Embodiments of the system may include one or more of the following features. In some embodiments, the system is a telecommunications network, or a radio access network (RAN). In some embodiments, the method may further include modifying the query according to an experience base, the experience base including correspondences between historical queries and historical answers.

In some embodiments, the method further includes storing a correspondence between the query and the answer in the experience base.

In some embodiments, the method further includes receiving, from a user device, feedback relating to the obtained information; and modifying the experience base in accordance with the feedback.

In some embodiments, the answer comprises computer code, and the method further include applying the answer to a data set that describes the RAN comprises executing the computer code using the data set.

In some embodiments, the query includes a question and at least one of a context and a constraint.

In some embodiments, the knowledge base includes a vector database, wherein the vector database modifies the query in accordance with at least one of a structural glossary, one or more rules, and unstructured documents.

In an embodiment, a system with one or more hardware processors and one or more non-transitory machine-readable storage media is encoded with instructions. When executed by the one or more hardware processors, the system performs operations including: receiving information of a database, wherein the database uses domain-specific terms; constructing a domain-specific vector base comprising vector embeddings of the domain-specific terms; receiving a natural language query from a user; generating query-specific vector embeddings of the natural language query; searching the domain-specific vector base based on the query-specific vector embeddings to identify one or more domain-specific terms that correspond to a term in the natural language query; transforming, using a fine-tuned large language model (LLM), the natural language query into a domain-specific query based on the identified one or more domain-specific terms and the natural language query; generating executable code based on the domain-specific query; and executing the executable code that invoke one or more APIs of the database for data retrieval or management.

In some embodiments, the operations further include: detecting runtime errors during the execution of the executable code, wherein the runtime errors include unhandled exceptions, execution failures, resource leaks, or other anomalies occurring during runtime; updating the executable code based on the domain-specific query and the runtime errors, wherein the updating includes invoking predefined exception handling routines corresponding to the runtime errors; and executing the updated executable code.

In some embodiments, searching the domain-specific vector base based on the query-specific vector embeddings includes, for a natural language term in the natural language query from the user, identifying one or more of a database table name, a column name, a variable, or a data type of the database that are corresponding to the natural language term based on vector-embedding search.

In some embodiments, in response to multiple database parameters being identified as corresponding to the natural language term, displaying the multiple database parameters for user selection; and adding the user selection as training data for further training of the fine-tuned LLM.

In some embodiments, the domain-specific terms include one or more of data schemes, schemas, column descriptions, acronyms used in the database, internal terms in the database, or metadata associated with the database.

In some embodiments, the operations further include configuring the one or more APIs of the database to access one or more tools provided by the database, wherein the one or more tools include a visualization tool, a virtualized network management portal, or a dashboard.

In some embodiments, the database is associated with a Radio Access Network (RAN), and the executing the executable code includes generating a visualization of statistics of the RAN in response to the natural language query from the user.

In some embodiments, the generating the query-specific vector embeddings of the natural language query includes: constructing a prompt comprising the natural language query; feeding the prompt to a first LLM, wherein the first LLM is configured to process the prompt using a transformer-based neural network architecture and generate a standardized representation of the natural language query; and generating the query-specific vector embeddings based on the standardized representation of the natural language query.

In some embodiments, the executable code includes one or more of SQL scripts or Python script, Python code, or other suitable programming language.

In some embodiments, generating the executable code based on the domain-specific query includes: automatically generating a machine-readable prompt comprising the domain-specific query and metadata extracted from the domain-specific vector base feeding the prompt to a second LLM trained to generate coding instructions based on the prompt, wherein the second LLM is trained on datasets comprising coding instructions to produce structured coding instructions suitable for automated code generation; and processing, by a code generator, the plurality of coding instructions to automatically generate executable code, wherein the code generator translates the coding instructions into source code in an interpreted programming language compatible with the database's APIs, and wherein the source code is executed by an interpreter or runtime environment to perform operations invoking the one or more APIs of the database.

In further embodiments, a hybrid retrieval system transforms user queries to computer-executable code. The hybrid retrieval system includes a vector-search module configured to: generate vector embeddings for a plurality of technical parameters associated with a database; generate a vector embedding for a natural language query provided by a user; and perform an embedding-based search between the vector embedding of the natural language query and the vector embeddings of the plurality of technical parameters to identify a subset of relevant technical parameters.

The hybrid retrieval system may further include a domain-specific language model (LLM) configured to: receive the subset of relevant technical parameters and the natural language query; perform semantic analysis of the natural language query in a context of the subset of relevant technical parameters; select one or more technical parameters from the subset that correspond to the natural language query based on the semantic analysis; and transform the natural language query to a domain-specific query based on the one or more selected technical parameters.

The hybrid retrieval system may further include a fine-tuning module configured to iteratively fine-tune the domain-specific LLM, and during each iteration: collect user interaction data comprising the natural language query, the one or more technical parameters selected by the domain-specific LLM, and user feedback; processing the user interaction data to generate training data pairs, wherein the processing comprises cleaning, normalizing, and structuring the user interaction data into key-value pairs with associated metadata suitable for machine learning algorithms; and fine-tune the domain-specific LLM model using the training data pairs to adapt the system to evolving user language patterns and domain-specific terminologies.

Other features and aspects of the disclosed technology will become apparent from the following detailed description, taken in conjunction with the accompanying drawings, which illustrate by way of example, the features in accordance with embodiments of the disclosed technology. The summary is not intended to limit the scope of any inventions described herein, which are solely defined by the claims attached hereto.

### BRIEF DESCRIPTION OF THE DRAWINGS

The technology disclosed herein, in accordance with one or more various embodiments, is described in detail with reference to the following figures (hereafter referred to as “FIGS.”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram of a domain-specific management system according to some embodiments of the disclosed technology.

FIG. 2 is a block diagram of the knowledge base according to some embodiments of the disclosed technology.

FIG. 3 is a flowchart illustrating a process for management of a RAN according to some embodiments of the disclosed technology.

FIG. 4 illustrates prompt construction according to some embodiments of the disclosed technology.

FIG. 5 illustrates an example of an LLM failing to follow the specified format.

FIG. 6 illustrates a system diagram of a context-aware data management system, in accordance with some embodiments.

FIG. 7 illustrates the fine-tuning process and deployment of the domain-specific LLM in the context-aware data management system, as part of a context-aware data management system, in accordance with some embodiments.

FIG. 8 illustrates an example computing system that may be used in implementing various features of embodiments of the disclosed technology.

### DETAILED DESCRIPTION

Disclosed herein are systems and methods for AI-assisted radio access network (RAN) management including monitoring, querying, analysis, and control functions. The disclosed technology, described in terms of the RAN knowledge domain, is also applicable to complex systems in other knowledge domains.

Recent advances in AI have given rise to Large Language Models (LLM) such as ChatGPT and GPT-4 released by OpenAI. The human interface for LLM is naturally interactive and flexible. For machine intelligence, LLM with different types of agents can conduct complicated interaction and reasoning with the environment. These agents include prompting-based Chain-of-Thought, ReACT agent, and others. Developing new intelligence systems with LLM as the core interface and reasoning component are becoming a fashionable paradigm. The disclosed technology employs LLM and LLM-based telecom agents to synthesize all network operational functions together, to make next-generation RAN operations more interactive, flexible, efficient, and reliable.

The use of current LLM implementations for RAN management presents several challenges. For example, some LLM implementations such as GPT Code Interpreter require users to upload their data to the cloud, creating a data privacy issue. Furthermore, general-purpose LLMs cannot understand the domain-specific language used in managing a RAN, and do not have access to domain-specific and private information such as internal wiki and specifications. Even though a very powerful general-purpose LLM might improve RAN management somewhat, the cost would be high. Hallucinations are common in LLMs, and can be catastrophic on mission-critical tasks. Finally, streaming data and data in large datalakes are not natively handled, and would require uploading vast quantities of data.

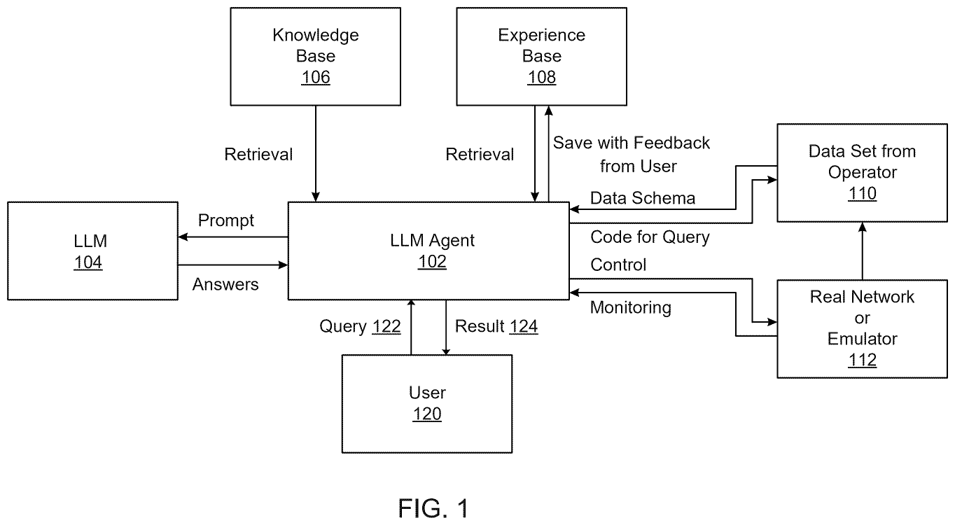

FIG. 1 is a block diagram of a domain-specific management system according to some embodiments of the disclosed technology. As an example, the domain here refers to a RAN, but a person skilled in the art would be able to apply the similar architecture and workflow to other domains, such as oil drilling and exploration, seismograph analysis, weather prediction, essentially any domain that consists of large data sets and natural language processing of the large data set. In FIG. 1, the system may include an LLM Agent 102, an LLM 104, a Knowledge Base 106, an Experience Base 108, a Data Set from Operator 110, and a Real Network or Emulator 112.

The LLM 104 may be a commercially-available general-purpose LLM. For example, the LLM 104 may be ChatGPT, GPT-4, or a similar LLM. The LLM 102 may operate in the general knowledge domain, and may not necessarily have knowledge of the telecommunications knowledge domain.

The LLM Agent 104 may be implemented as software executing on a general-purpose computing system. The LLM Agent 104 may be a hybrid agent designed to minimize hallucination by the LLM 104. The LLM Agent 104 may provide prompts to the LLM 104 based on a Query 122 received from a User 120, and may receive corresponding answers and/or code from the LLM 104. The LLM Agent 104 may generate a Result 124 to the Query 122 based on the answer received from the LLM 104, which may be further augmented by analyzing the Data Set from Operator 110 based on Code for Query.

The Knowledge Base 106 may contain knowledge of the telecommunications knowledge domain. For example, the Knowledge Base 106 may include correspondences between language specific to the telecommunications knowledge domain and language in the general knowledge domain of the LLM 104. The Knowledge Base 106 therefore allows the LLM Agent 102 to translate highly technical queries into more general queries that the LLM 104 can better understand and process.

The Experience Base 108 may contain knowledge of prior queries and answers. For example, the Experience Base 108 may include correspondences between historical queries and historical answers. The Experience Base 108 may also incorporate feedback from users regarding historical query answers provided by the LLM Agent 102. This feedback may be used to improve prompts, add/update/delete information from the Knowledge Base 106, and handle biases in the system. Positive feedback from users regarding a particular solution may indicate that the solution is good for future use. In some embodiments, the Experience Base 108 is generated by an LLM.

These correspondences and feedback may be stored and retrieved under an AI framework. For example, the AI framework may be the retrieval augmented generation (RAG) framework, the Reflexion framework, or similar AI frameworks. The Experience Base 108 allows the LLM Agent 102 to apply this experience knowledge to improve prompts provided to the LLM 104 as well as answers provided by the LLM 104. In some cases, for example with frequently-asked questions, the stored answers can be re-used, and no interaction with the LLM 104 is needed. In addition, telecommunication systems such as RANs generally have a lot of code, pipelines, and functionalities that can be augmented and used with the disclosed system. This existing software can be called by the LLM Agent 102 and executed without LLM calls. Thus, the disclosed system overlays on existing software to extend its applications.

The Real Network or Emulator 112 may be the actual RAN or an emulator of the RAN. An emulator may be used when testing the system. The RAN may be used when the system is operational. The LLM agent 102 may monitor the Real Network or Emulator 112, and may provide control inputs to the Real Network or Emulator 112.

The Data Set from Operator 110 may be obtained from the real network or emulator 112. The LLM Agent 102 may obtain the data schema of the data set from the Data Set from Operator 110, and may apply code for querying to the Data Set from Operator 110 to obtain query answers for users. The Data Set from Operator 110 may include a configuration management database and/or a performance management database.

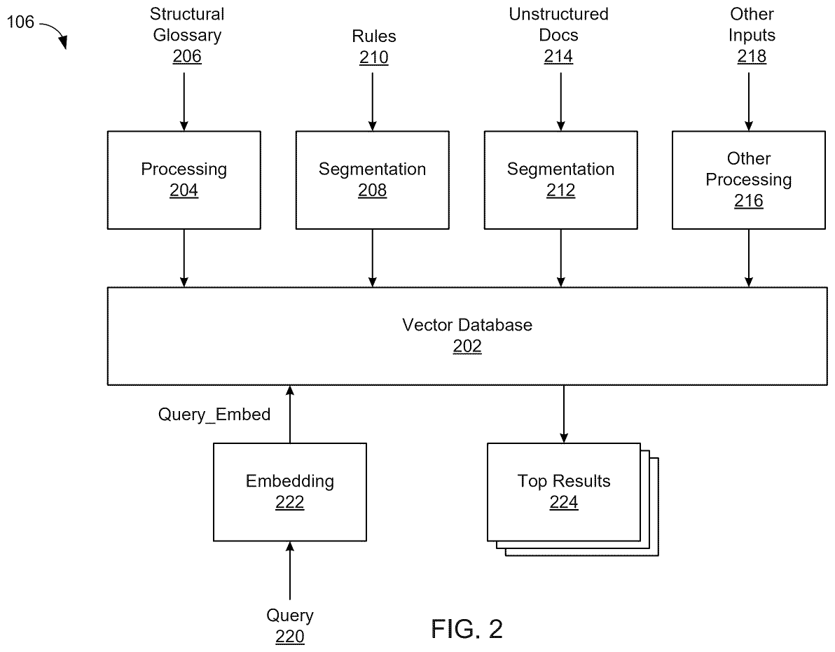

FIG. 2 is a block diagram of the Knowledge Base 106 according to some embodiments of the disclosed technology. The Knowledge Base 106 may include a Vector Database 202. The Vector Database 202 may be implemented using an AI-based similarity search. Such search techniques provide quick searches for embeddings of multimedia documents that are similar to each other. These search techniques solve the limitations of traditional query search engines that are optimized for hash-based searches, and provides more scalable similarity search functions.

The Vector Database 202 may be loaded from multiple knowledge sources. A Structural Glossary 206 may be processed at 204 and loaded into the Vector Database 202. The Structural Glossary 206 may include correspondences between language specific to the telecommunications knowledge domain and language in the general knowledge domain of the LLM 104. Additional telecommunications domain knowledge may be loaded into the Vector Database by segmenting Unstructured Documents 214 at 212. The Unstructured Documents 214 may include specifications, books, and similar unstructured documents. Other Inputs 218 may be loaded into the Vector Database 202 by other processing 216.

The knowledge sources may include Rules 210 that can be loaded into the Vector Database by segmentation at 208. Existing agents such as ReACT or Plan-and-execute make plans, by their own knowledge, which could be wrong due to either hallucination or lack of domain knowledge. The Rules 210 may include rules that ensure proper prompts are provided to the LLM 104.

Once the vector database 202 has been loaded, the knowledge base may be put into operation. A user query 220 may be embedded into the vector database at 222. In response, the vector database 202 may output one or more top results 224. The LLM agent may provide these results 224 as one or more prompts to the LLM 104.

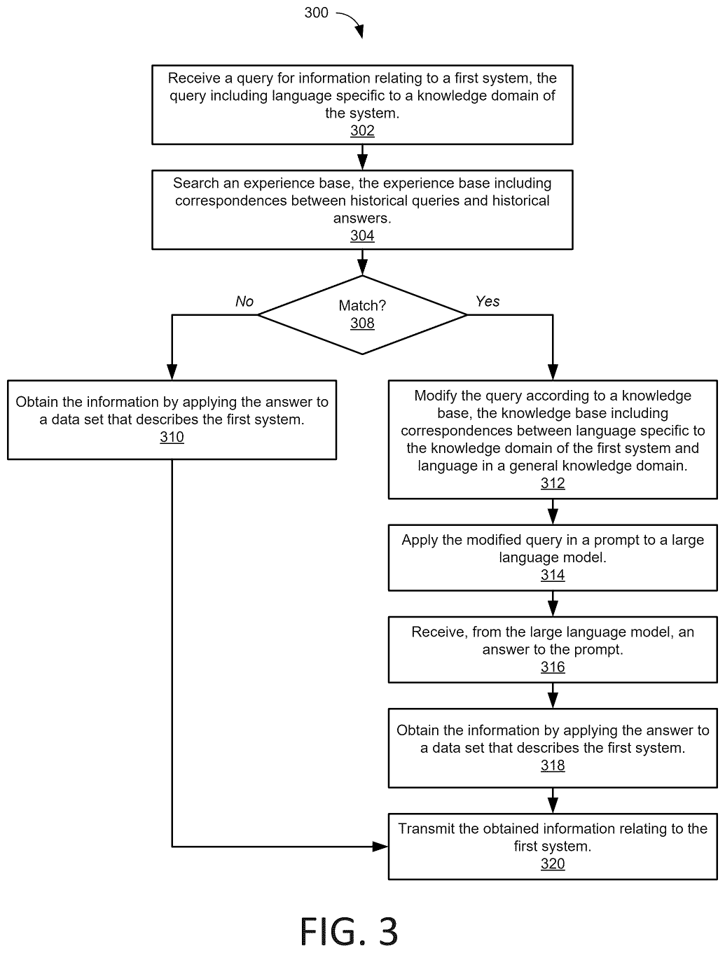

FIG. 3 is a flowchart illustrating a process 300 for management of a RAN according to some embodiments of the disclosed technology. For example, the process 300 may be implemented by the RAM management system of FIGS. 1 and 2.

The elements of the process 300 are presented in one arrangement. However, it should be understood that one or more elements of the process may be performed in a different order, in parallel, omitted entirely, and the like. Furthermore, the process 300 may include other elements in addition to those presented. For example, the process 300 may include error-handling functions if exceptions occur, and the like.

Referring again to FIG. 3, the process 300 may include receiving a query for information relating to a first system, the query including language specific to a knowledge domain of the system, at 302. In the example of FIG. 1, the Query 122 may be received by the LLM Agent 102 from a User 120. To receive the Query 122, the LLM Agent 102 may interact with User 120 to get the query, along with any contexts and/or constraints.

Referring again to FIG. 3, the process 300 may include searching an experience base, the experience base including correspondences between historical queries and historical answers, at 304. In the example of FIG. 1, the LLM Agent 102 may search the Experience Base 108 using the Query 122.

Referring again to FIG. 3, when at 308 the experience base includes a query that matches the query for information relating to the first system, the process 300 may include steps 310 and 320. The process 300 may include obtaining the information by applying the answer to a data set that describes the first system, at 310. The process 300 may include transmitting the obtained information relating to the first system, at 320. In the example of FIG. 1, the LLM Agent 102 may apply the answer to the data set from operator 110. When the answer includes code, the LLM 104 may execute the code against the data set from operator 110. The LLM Agent 102 may then transmit the Result 124 to the User 120.

Referring again to FIG. 3, when at 308 the experience base does not include a query that matches the query for information relating to the first system, the process 300 may include steps 312-320. The process 300 may include modifying the query according to a knowledge base, the knowledge base including correspondences between language specific to the knowledge domain of the first system and language in a general knowledge domain, at 312. In the example of FIG. 1, the LLM agent may modify the query according to contents of the Knowledge Base 106.

Referring again to FIG. 3, the process 300 may include applying the modified query in a prompt to a large language model (LLM), at 314. In the example of FIG. 1, the LLM Agent 102 may provide the prompts to the LLM 104.

Referring again to FIG. 3, the process 300 may include receiving, from the LLM, an answer to the prompt, at 316. In the example of FIG. 1, the LLM Agent 102 may receive an answer to the prompt from the LLM 104. The LLM 104 may choose a tool and compose the action input. In the example of writing code as a tool, the LLM 104 may write code to access the data set from operator 110. If the LLM agent 102 determines the code is not correct, the process 300 may return to step 312.

Referring again to FIG. 3, the process 300 may include obtaining the information by applying the answer to a data set that describes the first system, at 318. The process 300 may include transmitting the obtained information relating to the first system, at 320. In the example of FIG. 1, the LLM agent may apply the answer to the Data Set from Operator 110. When the answer includes code, the LLM 104 may execute the code against the Data Set from Operator 110. The LLM Agent 102 may then transmit the Result 124 to the User 120.

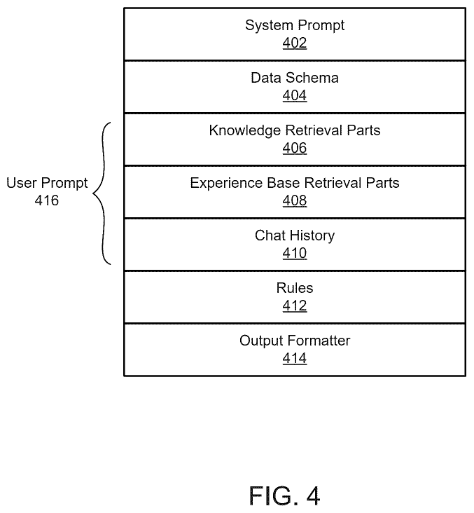

FIG. 4 illustrates prompt construction according to some embodiments of the disclosed technology. In the example of FIG. 1, the LLM Agent 102 may construct the prompt, and then provide the prompt to the LLM 104. Referring to FIG. 4, the prompt may include a system prompt 402, a data schema 404, knowledge retrieval parts 406, experience base retrieval parts 408, a chat history 410, rules 412, and an output formatter 414. The system prompt 402 may be a general description of the LLM agent 102. The data schema 404 may be the data schema of the data set from operator 110. The knowledge retrieval parts 406 may be information obtained from the knowledge base 106 by the LLM Agent 102. The experience base retrieval parts 408 may be information obtained from the experience base 108 by the LLM Agent 102. The chat history 410 may be {the historical context of the queries between the LLM 104 and LLM Agent 102, which may persist over sessions or be purged in between sessions.} The rules 412 may be specific rules obtained from the Knowledge Base 106 by the LLM Agent 102. The output formatter 414 may control the LLM 104 to generate an answer with a specified format. Together the knowledge retrieval parts 406, the experience base retrieval parts 408, and the chat history 410 may be considered the user prompt 416.

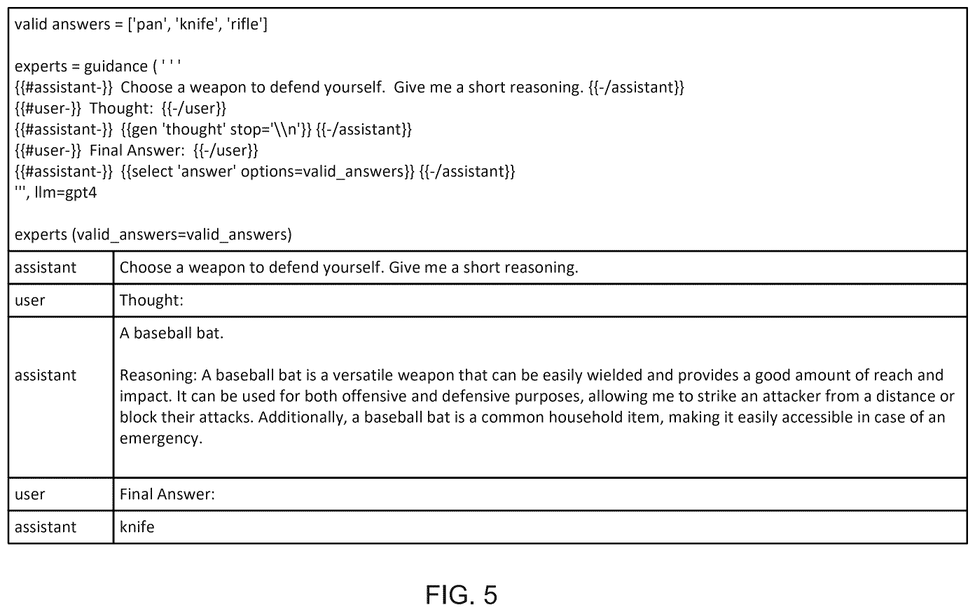

A big part of hallucination and case failures are due to the LLM 104 not following the specified output format. FIG. 5 illustrates an example of an LLM failing to follow the specified format. Referring to FIG. 5, a prompt asks the LLM to choose a weapon, and constrains the choices to pan, knife, and rifle. Despite these constraints, the LLM chooses a baseball bat.

Therefore, some embodiments employ guidance to control the answers provided by the LLM 104. Guidance can force the LLM 104 to generate the next token, chosen from the existing pre-defined list, thus forcing the LLM 104 to follow the instructions in the prompt. For example, returning to FIG. 5, guidance forces the final answer to follow the specified format by choosing knife.

It is possible that the code generated by the LLM may be malicious, either due to an intentional attack or a hallucination. For example, the generated code may contain the file os.cmd, which could lead to system meltdown. To avoid this problem, the system may include guardrails such that generated code cannot have the ability to deal with files. In some embodiments, the guardrails are implemented by tuning the prompt such that unwanted actions are discouraged. Alternatively, some embodiments post-process the code generated by the LLM to detect unacceptable actions or code blocks. In addition, user profiles may be employed to control the kinds of actions each user type can take.

Some embodiments employ a smart listener. The listener may have the ability to analyze why a condition is triggered by querying the knowledge base. The listener can even be allowed to perform some control, for example to automatically resolve or alleviate network problems. The listener may be built from interactive querying. When users are satisfied with the existing results, the code may be made persistent to become a listener, which can be run in the background linked to the data set from operator.

The disclosed uses of LLM provide advantages over existing systems in all RAN management functions: monitoring, querying, analysis, and control.

In querying, the first advantage is flexibility. The disclosed systems can perform complicated tasks without requiring the operator to write explicit code. This advantage provides fast data visualization and analytics, allows customized queries, and improves the efficiency of the system. The natural language nature of LLM makes the querying process interactive, via simple language exchange. Customized queries allow the operator to ask clear and unambiguous questions, which bolsters the performance of this system.

For monitoring the RAN, an English-described dashboard design is easily translated by the LLM to generate listener code that is ready-to-run, which improves the flexibility and efficiency of the whole process. Moreover, the designing of the listener may be interactive, which further improves the customer experience.

For controlling the RAN, the use of LLM helps with reasoning about an action to control, especially when the reasoning is already proved and written as a standard operational procedure.

The disclosed technologies also provide a hub for all other functionalities of the RAN. Users can call other functionalities (such as rAPPs) via LLM instead of writing code to combine multiple rAPPs. This makes other rAPPs easy to monitor and visualize. Using LLM here makes RAN management more efficient, more flexible, and easier-to-use.

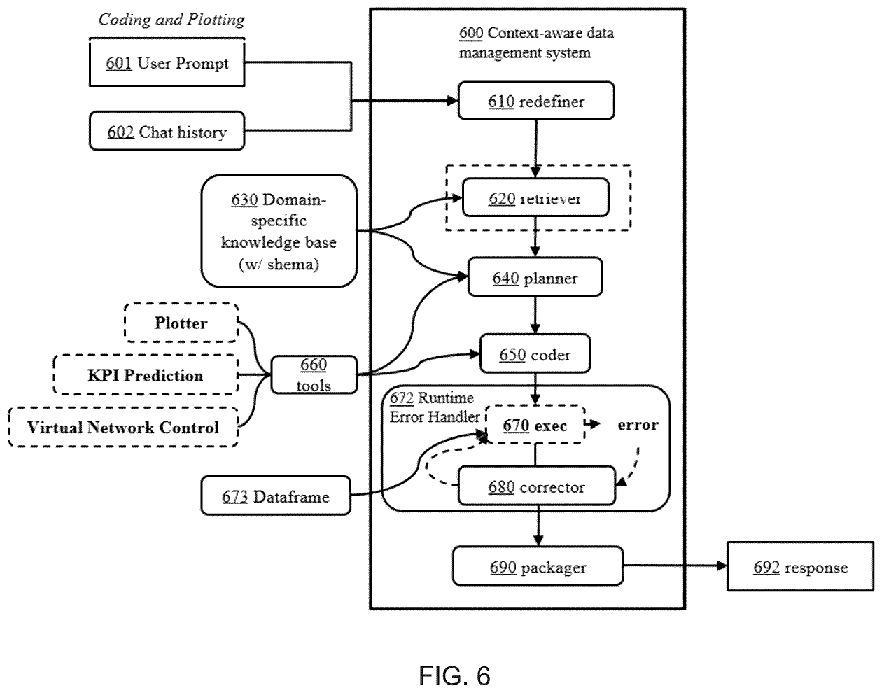

FIG. 6 illustrates a system diagram of a context-aware data management system 600, in accordance with some embodiments. As described in the background section, in today's data-driven organizations, the ability to access and analyze complex datasets is crucial for informed decision-making. Databases store vast amounts of technical data that can provide valuable insights when queried effectively. However, interacting with these databases typically requires specialized knowledge of query languages, programming skills, and an understanding of complex database schemas. This creates a significant accessibility barrier for users who lack technical expertise but require data insights to perform their roles effectively.

Traditional data retrieval systems often rely on structured query languages like SQL or require users to write code in programming languages such as Python. These methods necessitate a steep learning curve and are impractical for users whose primary expertise lies outside of technical fields. Consequently, non-technical users are dependent on technical staff to extract and interpret data, often leading to delays and inefficiencies in the decision-making process.

Moreover, within large organizations, different departments and teams often develop their own specialized terminologies, acronyms, and jargon. This lack of standardized language presents additional challenges for data retrieval systems. Conventional systems struggle to interpret these unique terms, resulting in miscommunication, incorrect data retrieval, and reduced overall efficiency.

Existing solutions lack the adaptability to accommodate the dynamic and evolving language used by various user groups within an organization. They are typically static and cannot learn from user interactions or adapt to new terminology over time. This inflexibility hampers the system's ability to provide accurate and relevant responses to user queries, especially as organizational language evolves.

With the advancement of large language models (LLMs), some existing systems have attempted to enhance data retrieval by combining domain-specific retriever-augmented generation (RAG) systems with general-domain LLMs. In these configurations, the general-domain LLM serves as an interface, handling communication with the user in natural language, while the domain-specific RAG system stores vector embeddings of domain-specific documents and data entries. When a user submits a query, the domain-specific RAG identifies the most relevant documents or data entries, and then generates a response that incorporates the retrieved domain-specific information.

While this approach enables general-domain LLMs to ingest and integrate domain-specific information into their responses, it comes with significant limitations. First, this approach fails to provide customized or personalized interface for different users (e.g., departments or teams) using different terms or expressions to refer to the same technical term or data set. Second, another major drawback is that these systems are primarily designed for information retrieval rather than active data management, which includes taking actions on the retrieved data. The general-domain LLM and the RAG system work in tandem to retrieve relevant documents or data, but neither has the capability to generate executable code, manage database operations, or modify the underlying domain-specific datasets. For complex technical fields, where dynamic database management is required alongside information retrieval, these systems fall short of addressing more advanced user needs, such as generating or executing database queries.

Additionally, the reliance of traditional RAG systems on vector similarity for retrieving documents or parameters introduces challenges, especially when handling large datasets with closely related terms or concepts. Vector similarity methods, while effective at identifying general relationships, often struggle to capture subtle semantic differences between related terms. For instance, in a telecommunications network, terms like “network load,” “cell load,” and “user load” may share similar vector embeddings, but they refer to distinct technical concepts. Traditional RAG systems may not have the necessary depth of understanding to differentiate between such terms, leading to ambiguous or inaccurate results.

As the size of the dataset grows, this ambiguity compounds, making it increasingly difficult for RAG systems to maintain accuracy. The precision of retrieval becomes critical, as any errors or imprecise mappings at the retrieval stage directly affect the quality of the generated answers. Consequently, if a retrieval system incorrectly identifies or conflates related parameters, the final response provided by the LLM may fail to align with the user's original intent, reducing the system's overall utility and effectiveness.

To overcome the limitations of the existing solutions, the context-aware data management system 600 is introduced in this application. For illustration purposes, FIG. 6 depicts an example context-aware data management system 600 and how it interacts with domain-specific information.

Initially, the domain-specific information may be retrieved from domain-specific databases. The domain-specific information may include structural details, such as column names, data formats, internal definitions, and acronyms specific to the database in question. To incorporate these databases into the system 600, users can upload database credentials, allowing the system 600 to securely log in and learn the structure of the database. This involves identifying each column and understanding its associated description and metadata. Additionally or alternatively, users may upload schemas in various formats, such as CSV, PDF, or XML files, each containing a comprehensive description of the database columns and their definitions. These uploaded schemas help the system 600 recognize the relationships between different data fields, enabling it to efficiently interpret user queries and map them to the correct parameters within the database. Through this process, the system 600 builds a domain-specific knowledge base and schema 630, storing the data schemes, column descriptions, acronyms used in the database, internal terms in the database, metadata associated with the database, data formats (e.g., percentage, number, fraction), and other domain-specific terms.

The knowledge base and schema 630 serves as a reference that the system 600 uses to understand the unique language of the domain, including the internal definitions and specific terminology employed within the user's organization. This enables the system to parse natural language queries accurately, interpreting terms and phrases that may otherwise be ambiguous without a proper understanding of the context. For instance, the system 600 can differentiate between terms like “load” or “capacity” by referencing the definitions learned from the uploaded databases.

Furthermore, the system 600 can leverage various tools 660 or APIs for managing and accessing the database, which can be incorporated into the system 600 during the setup phase. These tools 660 may include programs such as dashboards for visualizing data, KPI predictors for forecasting key performance indicators, and virtual network controller such as TeraVM controls for network testing and management. In some embodiments, the tools 660 may expose or register their respective APIs in the system 600. This registration process could involve securely exchanging API keys or tokens, ensuring the system has the appropriate permissions to access the tools. These domain-specific tools 660 may be used behind the scenes to carry out user requests, such as generating reports, predicting performance metrics, or controlling specific elements of the network. In some embodiments, the system 600 can also directly query databases using protocols like SQL or GraphQL to extract real-time data or execute commands on the tools 660. Additionally, Remote Procedure Calls (RPCs) may be used to remotely invoke specific functions in the tools 660, enabling the system 600 to control network elements or simulate conditions like network load, with results returned for further processing.

In some embodiments, the context-aware data management system 600 may include a redefiner 610, a retriever 620, a planner 640, a coder 650, a runtime error handler 672, and a packager 690. In some embodiments, the knowledge base and schema 630 and/or the tools 660 may be integrated into the system 600 as well.

To illustrate the workflow of system 600, an example user inquiry involving coding and plotting is shown in FIG. 6. In this scenario, the user prompt 601 includes a natural language query that triggers a search for specific data from the domain-specific database and executes the relevant tool(s) on the retrieved data.

In addition to the user prompt 601, the current user's chat history 602 or previous interactions with the system 600 may also be used as an input to the system 600. In some cases, this history data 602 is stored in a memory space associated with the query session and can be used to train the system 600 for subsequent queries. In other cases, the user may explicitly provide the history data 602 to offer the system 600 additional context. This historical data 602 provides valuable context to the system regarding how the particular user interacts, including their inquiry style, preferred terminology, system responses, and/or feedback.

In some embodiments, the redefiner 610 may be configured to reformat the user inquiry into a standardized format and perform vectorization and embedding on the standardized inquiry. For example, the user inquiry may be fed into a first LLM as a prompt, where the first LLM utilizes a transformer-based neural network architecture to process the prompt and generate a standardized representation of the natural language query. An embedding engine may then create query-specific vector embeddings based on this standardized representation of the natural language query.

Standardizing the user inquiry before vectorization is designed to improve the accuracy of the vectorization step. Natural language queries often contain variations in phrasing, terminology, or syntax, which can introduce ambiguity during the embedding process. By reformatting the inquiry into a consistent, standardized structure, the system reduces variability and ensures that semantically similar queries are treated consistently during vectorization. This step enhances the precision of the embedding engine, as the model can more accurately capture the underlying intent and meaning of the query, leading to improved retrieval and processing of relevant domain-specific information.

For example, consider two user inquiries: “How many users are connected to the 5G network?” and “What is the number of users currently on the 5G network?”. Although these inquiries are phrased differently, they essentially ask for the same information. The standardization process would reformat both inquiries into a uniform representation, such as “Retrieve current number of users connected to the 5G network.” This standardized version removes variations in phrasing and allows the embedding engine to generate more accurate vector embeddings that focus on the core meaning of the query, improving the system's ability to retrieve the correct data.

After obtaining the vector embeddings of the natural language terms in the user inquiry, the retriever 620 is configured to perform a hybrid retrieval to identify the domain-specific terms from the knowledge base and schema 630 that correspond to the natural language terms. The hybrid retrieval process involves an initial vector-based search of the knowledge base embeddings (also called a domain-specific vector base) to identify a plurality of candidate domain-specific terms, such as a database table name, a column name, a variable, or a data type of the database that correspond to the vector embeddings of the natural language term. This vector-based search is followed by a fine-tuned, domain-specific LLM performing a secondary filtering of the candidate terms to accurately identify the domain-specific terms that match the natural language terms in the user inquiry. The fine-tuned LLM may take the identified domain-specific terms as input to generate a domain-specific query.

For example, in the context of a Radio Access Network (RAN), a user may query about the status of “network handovers” in a 5G network. Suppose the user submits a query: “What is the current status of handovers in the network?” Initially, the redefiner 610 transforms the query into a standard format, e.g., “status of handovers,” and the retriever 620 may convert the natural language terms, such as “status” and “handovers,” into vector embeddings and perform a search within the domain-specific knowledge base. This vector-based search might identify several candidate terms related to handovers, such as “successful handovers,” “failed handovers,” “handover latency,” and “handover attempts.” At this stage, the redefiner 610 only gathers and displays candidate terms.

Next, the fine-tuned LLM in the retriever 620 further refines these candidate terms by considering the context information, such as user's previous interactions with the system or their specific role within the organization. If the user's previous queries have shown a consistent focus on troubleshooting network performance issues—particularly on monitoring failure rates or error processes—the LLM would prioritize terms such as “failed handovers” and “handover latency.” Additionally, if the user is part of a team responsible for network stability and troubleshooting, the system would align the response to focus on identifying network inefficiencies, rather than routine operations like “successful handovers.” In some embodiments, the user-selected terms are stored along with the natural language terms as the training data to further fine-tune the domain-specific LLM.

As a result, the system generates a more precise query tailored to the user's historical preferences and role, such as “retrieve the current failure rate and latency for handovers in the 5G network.” By leveraging the user's previous queries and profile, the system ensures that the most relevant and actionable data is retrieved, focusing on the aspects of the network handovers that align with the user's interests in troubleshooting and network stability. This approach provides the user with more meaningful results that are closely aligned with their professional needs and operational focus.

The hybrid solution offers a significant technical advantage over traditional RAG systems by leveraging a two-step process for identifying domain-specific terms. In the hybrid approach, the vector-embedding search serves as an initial, less stringent mechanism for identifying a broad set of candidate terms, without needing to pinpoint the optimal term or terms immediately. This relaxed requirement allows the system to quickly narrow down potential matches. The fine-tuned LLM then refines this list by considering additional context, such as the user's historical interactions and profile, to filter out the most relevant domain-specific term or terms. In contrast, traditional RAG systems must rely solely on vector similarity to identify the optimal term based only on the current user query, with no awareness of prior interactions or user preferences. This often leads to less accurate results, as traditional RAGs do not incorporate valuable context to distinguish between closely related terms.

After the domain-specific terms are identified by the retriever 620, the planner 640 may generate a sequence of coding instructions based on the identified domain-specific terms, the corresponding information in the knowledge base and schema 630, and/or the natural language query. For instance, the domain-specific terms may include specific table names and/or column names in the database. The information in the knowledge base and schema 630 corresponding to the tables or columns may include data types, formats, or other relevant details required to accurately construct a database probe. This information, when combined with the domain-specific terms, allows the planner 640 to generate the appropriate query for retrieving the necessary data. Additionally, the natural language query may provide further instructions regarding the desired action to be performed on the query result, such as plotting a visualization, generating a file in a specific format (e.g., CSV, JSON), setting up alerts based on specific thresholds, or performing statistical analysis. By considering these inputs, the planner 640 can efficiently generate coding instructions to fulfill the user's request and interact with the database in a context-aware and action-oriented manner. In some embodiments, the planner 640 may be implemented using tools like OpenAI GPT, Codex, or Google PaLM, which can be used to translate natural language queries into step-by-step coding instructions.

The coder 650 may receive the sequence of coding instructions generated by the planner 640 and, based on these instructions, generate executable code in an interpreted programming language compatible with the database's APIs. The code is designed to interact with the domain-specific database or perform other actions as specified in the user's natural language query. The coder 650 translates the high-level coding instructions into low-level programming constructs, using appropriate languages such as Python, SQL, or other appropriate programming languages, depending on the nature of the task. For instance, if the instruction involves querying a database, the coder 650 may generate a python code or an SQL query with the necessary SELECT, WHERE, and JOIN clauses based on the table names, column names, and data formats provided by the planner 640. If the query result is intended to be visualized, the coder 650 can incorporate libraries such as Matplotlib or Plotly to generate plots. Similarly, if the result needs to be exported, the coder 650 can write scripts that output the data in formats like CSV or JSON. Additionally, the coder 650 can embed logic for setting up alerts or thresholds, which may involve creating triggers within the database or scheduling tasks for continuous monitoring. In some embodiments, the coder 650 may be implemented using tools like Codex, DeepMind AlphaCode, or GitHub Copilot, which can generate executable scripts in languages like Python or SQL from these high-level instructions.

The runtime error handler 672 includes a runtime environment (denoted as exec 670 in FIG. 6) in which the executable scripts generated by the coder 650 are executed. In some embodiments, the scripts may interact with Python data structures, such as DataFrames (commonly used in data manipulation libraries like Pandas), to organize, filter, and process the data.

The runtime error handler 672 further includes a corrector 680 for catching runtime errors, such as unhandled exceptions, execution failures, resource leaks, or other anomalies occurring during runtime. Depending on the nature of the runtime errors, the corrector 680 may automatically invoke predefined exception handling routines corresponding to the runtime error to update the code and resolve the issues.

For example, if code encounters an issue such as trying to access a non-existent column in a DataFrame 672, the corrector 680 can modify the code to either rename the column based on the correct schema or omit it from the query. Similarly, if code attempts to perform an unsupported operation on a DataFrame, such as dividing a string-based column by a numeric column, the corrector 680 can identify the error and adjust the operation by converting the data type. In cases where a resource leak occurs, such as an unclosed file handle or database connection, the corrector 680 can automatically insert code to properly release these resources after the DataFrame processing is complete. As another example, if code generates a syntax error (such as a missing semicolon or an incorrect function name), the corrector 680 can identify and modify the faulty line of code to fix the syntax, ensuring the code runs successfully. Similarly, in the event of a type mismatch error (e.g., the code attempts to use a string where an integer is required), the corrector 680 can adjust the variable type or add type casting to ensure compatibility. In cases of resource leaks (such as open database connections that are not properly closed), the corrector 680 may insert commands to release resources after their use, preventing memory issues or performance degradation. For more complex execution failures, like failed database queries due to missing fields, the corrector 680 can attempt to adjust the query by removing or replacing invalid field references.

In some embodiments, the execution of code may involve triggering one or more APIs (e.g., the tools 660) of the database for data retrieval or management, such as generating visualizations, making predictions, or executing network control commands.

For example, if the user inquiry requests plotting a performance summary, the code could query real-time data from the network database, aggregate it into a DataFrame, and use visualization tools (such as Matplotlib or Plotly) to generate visual outputs like line charts or heatmaps. These charts could be displayed on a dashboard, providing users with an intuitive way to interpret the data. Alternatively, the script may trigger a KPI predictor tool to analyze trends in the queried data and make predictions, such as forecasting potential network congestion points.

In more advanced use cases, the code may also interact with network control tools like TeraVM, triggering network configuration commands based on the obtained data. For instance, if the data reveals high traffic in a specific cell, the script may instruct the TeraVM tool to adjust radio resources dynamically, mitigating congestion. The ability to combine data retrieval with real-time actions ensures that the system not only answers the user inquiry but also provides actionable outcomes, such as optimizations or network adjustments based on the analyzed data.

In some embodiments, the optional packager 690 receives the output from the execution of the script and prepare it for final delivery. Once the script processes the user inquiry—whether by querying data, generating visualizations, or triggering network control actions—the packager 690 aggregates and formats this output into a cohesive response. The output may include raw data, visual representations (such as graphs or charts), predictions, or network commands. The packager 690 ensures that these various elements are properly organized, converted into the appropriate formats, and optimized for the type of response required by the user.

Once the output is packaged, it is passed on to generate the response 692. This response 692 could take different forms depending on the user's original request, such as displaying a visual chart on a dashboard, providing a downloadable file in formats like CSV or JSON, or presenting insights directly within the system's user interface. Additionally, the response 692 may include action-based outputs, such as confirmation of a network control command execution.

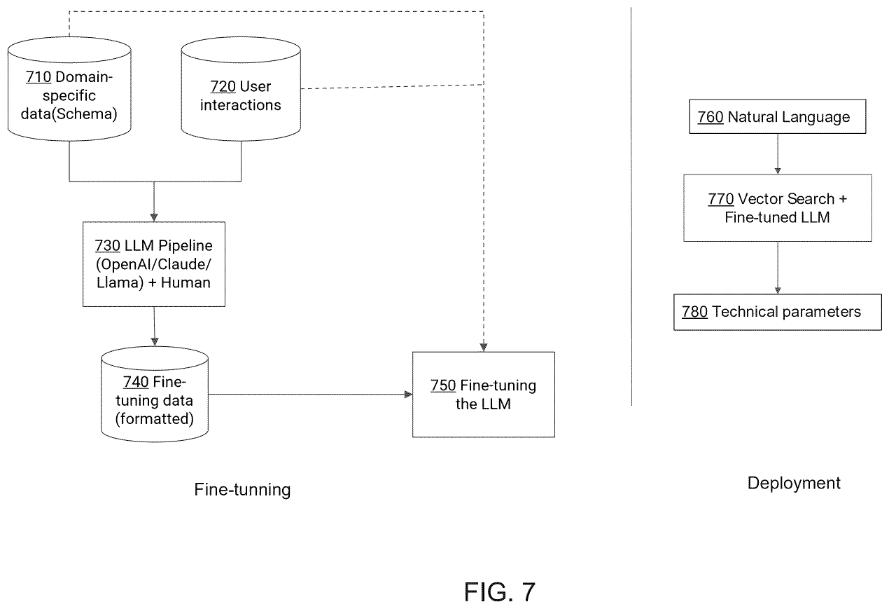

FIG. 7 illustrates the fine-tuning process and deployment of the domain-specific LLM in the context-aware data management system, in accordance with some embodiments.

The fine-tuning process of the domain-specific LLM in the context-aware data management system involves several stages designed to refine the model's ability to map natural language terms to domain-specific technical parameters. This process begins with gathering relevant data sources, followed by generating fine-tuning data through a two-step process involving both a generic LLM and human feedback, and finally fine-tuning the domain-specific LLM based on these mappings.

As shown in FIG. 7, the fine-tuning process starts with two data sources: domain-specific data 710 and user interactions 720. The domain-specific data 710 may encompass technical information such as Service Management and Orchestration (SMO) data, database schemas, parameters, formula knowledge, and other system-related data. This data serves as the technical foundation for fine-tuning, detailing how the system's data is structured and how various parameters interact. User interactions 720 track all the natural language queries and inputs provided by users, along with their objectives and other interaction patterns. These interactions help the system identify how users phrase their queries and what technical results they seek. By recording this data, the system can incorporate personalized usage into the fine-tuning process, enhancing the LLM's ability to understand and respond to user-specific language.

The fine-tuning data generation process is performed in two steps using a generic LLM and human feedback 730. In the first step, the generic LLM absorbs both domain-specific data 710 and historical user interactions 720, generating mapping pairs between technical terms and the natural language terms commonly used by the user. For example, a user query like “How can I adjust the signal strength of the 5G cell tower?” might be mapped to technical parameters such as adjust_signal_strength, cell_tower_id, and network_type=‘5G’.

The second step involves human validation—the system presents these generated pairs to human users, who can then review, edit, and purge the generated mappings as needed. This human feedback ensures that only accurate and context-appropriate mappings are stored. The validated mappings are saved as fine-tuning data 740 in the form of key-value pairs, where the key represents the natural language term, and the value represents the corresponding technical term or database parameter.

Once the fine-tuning data 740 is generated, the fine-tuning step 750 uses these key-value pairs to train the domain-specific LLM. This training allows the model to learn the mapping relationship between natural language queries and domain-specific technical parameters. The process utilizes existing LLM tools, which support user-provided training data, making it possible to refine the model based on the specific needs of the domain.

In some embodiments, in addition to the key-value pairs, the natural language terms from historical user queries are also considered during the fine-tuning process. The domain-specific data 710 and user interactions 720 provide essential context for this step, ensuring that the LLM is not only capable of understanding the technical language of the system but also how users naturally interact with it.

For example, if a user frequently asks how to adjust network parameters, the LLM will be fine-tuned to recognize similar future queries and map them to the appropriate technical actions, such as adjust_signal_strength. This enables the domain-specific LLM to respond accurately and efficiently, continuously improving based on real-world user interactions and domain-specific knowledge.

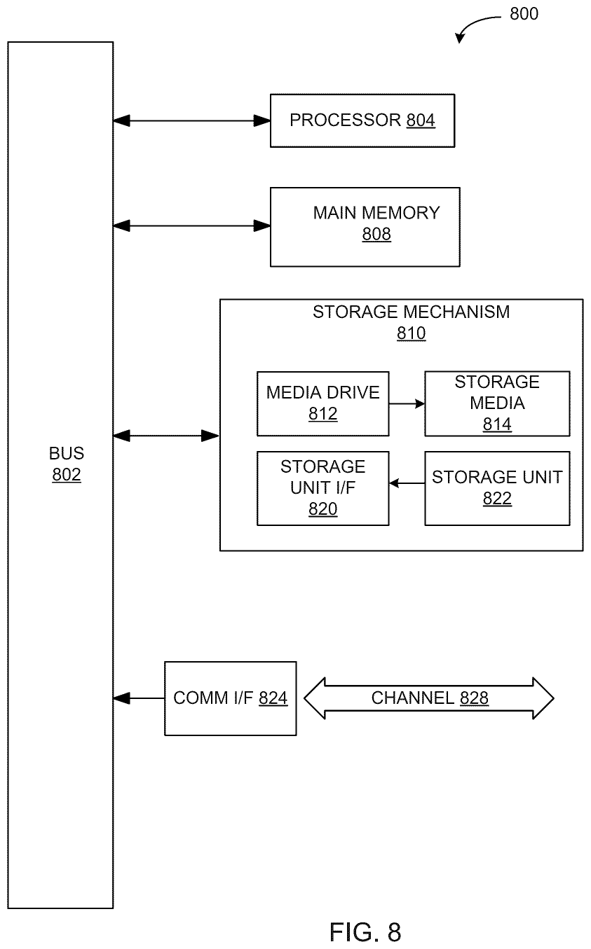

The fine-tuning process may be performed periodically (e.g., after collecting a certain number of user interactions) or triggered upon the creation of new domain-specific data. Once a round of fine-tuning is complete, the deployment of the fine-tuned LLM involves receiving a natural language query 760 and executing a two-step retrieval process, which includes a vector search followed by refinement using the fine-tuned LLM 770. The output of this process is a set of technical parameters 780 that are domain-specific and correspond to the natural language terms in the user query 760.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s). Communications or network interface(s) interface might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, comprising:
receiving a query for information relating to a system, the query including language specific to a knowledge domain of the system;
modifying the query according to a knowledge base, the knowledge base including correspondences between language specific to the knowledge domain of the system and language in a general knowledge domain;
applying the modified query in a prompt to a large language model (LLM);
receiving, from the LLM, an answer to the prompt;
obtaining the information by applying the answer to a data set that describes the system; and
transmitting the obtained information relating to the system.

2. The method of claim 1, wherein the system is a telecommunications network.

3. The method of claim 1, wherein the system is a radio access network (RAN).

4. The method of claim 1, further comprising:
modifying the query according to an experience base, the experience base including correspondences between historical queries and historical answers.

5. The method of claim 4, further comprising:
storing a correspondence between the query and the answer in the experience base.

6. The method of claim 4, further comprising:
receiving, from a user device, feedback relating to the obtained information; and
modifying the experience base in accordance with the feedback.

7. The method of claim 1, wherein the answer comprises computer code, and the method further comprises:
applying the answer to a data set that describes the RAN comprises executing the computer code using the data set.

8. The method of claim 1, wherein the query comprises:
a question and at least one of a context and a constraint.

9. The method of claim 1, wherein the knowledge base comprises:
a vector database, wherein the vector database modifies the query in accordance with at least one of a structural glossary, one or more rules, and unstructured documents.

10. A system, comprising:
one or more hardware processors; and
one or more non-transitory machine-readable storage media encoded with instructions that, when executed by the one or more hardware processors, cause the system to perform operations comprising:
receiving information of a database, wherein the database uses domain-specific terms;
constructing a domain-specific vector base comprising vector embeddings of the domain-specific terms;
receiving a natural language query from a user;
generating query-specific vector embeddings of the natural language query;
searching the domain-specific vector base based on the query-specific vector embeddings to identify one or more domain-specific terms that correspond to a term in the natural language query;
transforming, using a fine-tuned large language model (LLM), the natural language query into a domain-specific query based on the identified one or more domain-specific terms;
generating executable code based on the domain-specific query; and
executing the executable code that invokes one or more APIs of the database for data retrieval or management.

11. The system of claim 10, wherein the operations further comprise:
detecting runtime errors during the execution of the executable code, wherein the runtime errors include unhandled exceptions, execution failures, resource leaks, or other anomalies occurring during runtime;
updating the executable code based on the domain-specific query and the runtime errors, wherein the updating comprises invoking predefined exception handling routines corresponding to the runtime errors; and
executing the updated executable coding code.

12. The system of claim 10, wherein the searching the domain-specific vector base based on the query-specific vector embeddings comprises:
for a natural language term in the natural language query from the user, identifying one or more of a database table name, a column name, a variable, or a data type of the database that are corresponding to the natural language term based on vector-embedding search.

13. The system of claim 12, wherein:
in response to multiple database parameters being identified as corresponding to the natural language term, displaying the multiple database parameters for user selection; and
adding the user selection as training data for further training of the fine-tuned LLM.

14. The system of claim 10, wherein the domain-specific terms comprise one or more of data schemes, column descriptions, acronyms used in the database, internal terms in the database, or metadata associated with the database.

15. The system of claim 10, wherein the operations further comprise:
configuring the one or more APIs of the database to access one or more tools provided by the database, wherein the one or more tools include a visualization tool, a virtualized network management portal, or a dashboard.

16. The system of claim 10, wherein the database is associated with a Radio Access Network (RAN), and the executing the executable code comprise:
generating a visualization of statistics of the RAN in response to the natural language query from the user.

17. The system of claim 10, wherein the generating the query-specific vector embeddings of the natural language query comprises:
constructing a prompt comprising the natural language query;
feeding the prompt to a first LLM, wherein the first LLM is configured to process the prompt using a transformer-based neural network architecture and generate a standardized representation of the natural language query; and
generating the query-specific vector embeddings based on the standardized representation of the natural language query.

18. The system of claim 10, wherein the executable code comprise one or more of SQL scripts or python code.

19. The system of claim 10, wherein the generating the executable code based on the domain-specific query comprises:
automatically generating a machine-readable prompt comprising the domain-specific query and metadata extracted from the domain-specific vector base
feeding the prompt to a second LLM trained to generate coding instructions based on the prompt, wherein the second LLM is trained on datasets comprising coding instructions to produce structured coding instructions suitable for automated code generation; and
processing, by a code generator, the plurality of coding instructions to automatically generate executable code, wherein the code generator translates the coding instructions into source code in an interpreted programming language compatible with the database's APIs, and wherein the source code is executed in a runtime environment to perform operations invoking the one or more APIs of the database.

20. A hybrid retrieval system for transforming user queries to computer-executable code, comprising:
a vector-search module configured to:
generate vector embeddings for a plurality of technical parameters associated with a database;
generate a vector embedding for a natural language query provided by a user; and
perform an embedding-based search between the vector embedding of the natural language query and the vector embeddings of the plurality of technical parameters to identify a subset of relevant technical parameters;
a domain-specific language model (LLM) configured to:
receive the subset of relevant technical parameters and the natural language query;
perform semantic analysis of the natural language query in a context of the subset of relevant technical parameters;
select one or more technical parameters from the subset that correspond to the natural language query based on the semantic analysis; and
transforming the natural language query to a domain-specific query based on the one or more selected technical parameters;
a fine-tuning module configured to iteratively fine-tune the domain-specific LLM, and during each iteration:
collect user interaction data comprising the natural language query, the one or more technical parameters selected by the domain-specific LLM, and user feedback;
processing the user interaction data to generate training data pairs, wherein the processing comprises cleaning, normalizing, and structuring the user interaction data into key-value pairs with associated metadata suitable for machine learning algorithms; and
fine-tune the domain-specific LLM model using the training data pairs to adapt the system to evolving user language patterns and domain-specific terminologies.
